(19) United States
(12) Patent Application Publication
(10) Pub. No.: US 2025/0052288 A1
(43) Pub. Date: Feb. 13, 2025

(54) DISC BRAKE

(71) Applicant: HL MANDO CORPORATION, Pyeongtaek-si (KR)

(72) Inventor: Hatem SHAHIN, Pfaffenhofen (DE)

(73) Assignee: HL MANDO CORPORATION, Pyeongtaek-si (KR)

(21) Appl. No.: 18/381,427

(22) Filed: Oct. 18, 2023

(30) Foreign Application Priority Data
May 22, 2023 (DE) 102023204763.2

(51) Int. Cl. F16D 55/226; F16D 65/18; F16D 121/04; F16D 125/14

(52) U.S. Cl. CPC F16D 55/226; F16D 65/18; F16D 2121/04; F16D 2125/14

(57) ABSTRACT

The disc brake includes an inner brake pad and an outer brake pad respectively disposed on both sides of the brake disc; an inner back plate and an outer back plate respectively supporting outer sides of the inner brake pad and the outer brake pad, respectively, with the brake disc interposed therebetween; a hydraulic space formed inside the inner back plate to accommodate a working fluid; and a tube through which the working fluid is transferred to the hydraulic space so that the inner back plate moves toward the brake disc by hydraulic pressure.

### CROSS-REFERENCE TO RELATED APPLICATION

This application is based on and claims priority under 35 U.S.C. § 119 to German Patent Application No. 102023204763.2, filed on May 22, 2023 in the German Patent and Trade Mark Office, the disclosures of which are incorporated herein by reference.

### BACKGROUND

### 1. Field

Embodiments of the present disclosure relate to a disc brake for performing vehicle braking by pressing a disc, and more specifically, to a disc brake in which a piston is replaced with a hydraulic space formed inside a back plate.

### 2. Description of the Related Art

A brake system for performing braking has to be mounted in a vehicle, and various types of brake systems have been proposed for the safety of drivers and passengers.

Brake systems are largely divided into disc brakes and drum brakes. Among them, a disc brake generally includes inner and outer brake pads that press both sides of a disc, inner and outer back plates that support the brake pads, and a piston that forms hydraulic pressure and presses the inner back plates toward the disc.

The conventional disc brakes have been developed so that the pressure of a working fluid generated in a brake master cylinder is applied to a piston to push an inner brake according to a driver's braking command. The piston is installed to move forward and backward in an inner space of a brake housing, and serves to form hydraulic pressure according to the inflow of a working fluid. Recently, even in an electric disc brake in which both hydraulic and electric methods are applied, a piston installed to move forward and backward by hydraulic pressure is installed inside a housing without exception. As such, a disc brake including a piston is disclosed in Korean Patent Registration No. 10-2036092. However, as the demand for weight reduction of vehicles has recently increased, attempts have been made to improve the heavy and complex disc brake structure using conventional pistons.

### SUMMARY

Therefore, it is an aspect of the present disclosure to provide a disc brake that replaces a conventional piston with a hydraulic space formed inside a back plate so as to significantly reduce the weight of a vehicle.

It is another aspect of the present disclosure to provide a disc brake improved from a conventional brake pad structure without installing additional parts so as to reduce manufacturing costs and improve productivity.

It is another aspect of the present disclosure to provide a disc brake that applies a simple structure in which a working fluid flows to a hydraulic space inside a back plate through a tube so as to improve the efficiency of assembly and disassembly of brakes.

Additional aspects of the disclosure will be set forth in part in the description which follows and, in part, will be obvious from the description, or may be learned by practice of the disclosure.

In accordance with one aspect of the present disclosure, a disc brake includes: an inner brake pad and an outer brake pad disposed on both sides of a brake disc; an inner back plate and an outer back plate configured to support outer sides of the inner brake pad and the outer brake pad, respectively, with the brake disc interposed therebetween; a hydraulic space formed inside the inner back plate to accommodate a working fluid; and a tube configured to transfer the working fluid to the hydraulic space so that the inner back plate moves toward the brake disc by hydraulic pressure.

The inner back plate may include a connecting hole connected to the hydraulic space, in which the end of the tube is fixed, and through which the working fluid passes.

The connecting hole may be formed in a rear central portion of the inner back plate.

The hydraulic space may be formed over an entire surface of the inner back plate so that the entire surface of the inner brake pad is uniformly pressed when the working fluid is introduced through the tube.

The tube and the connecting hole may be provided as a plurality of tubes and a plurality of connecting holes, and the working fluid may be introduced into the hydraulic space through the plurality of tubes and connecting holes.

The connecting holes may be formed to be spaced apart from each other at equal intervals in a horizontal direction on both sides from the center of the inner back plate.

The tube may elastically extend so that the inner back plate is movable toward the brake disc when the working fluid is introduced.

In accordance with another aspect of the present disclosure, a disc brake includes: an inner brake pad and an outer brake pad disposed on both sides of the brake disc; an inner back plate and an outer back plate supporting the outer sides of the inner brake pad and the outer brake pad, respectively, with the brake disc interposed therebetween; a hydraulic space formed inside the inner back plate to accommodate a working fluid; and a tube through which the working fluid is transferred to the hydraulic space, wherein the inner back plate includes a first plate supporting a rear surface of the inner brake pad and a second plate fixed to a rear surface of the first plate and connected to the tube to form hydraulic pressure by the working fluid.

The second plate may be formed of a material that is more flexible than the first plate.

The second plate may include a connecting hole connected to the hydraulic space, in which the end of the tube is fixed, and through which the working fluid passes.

The connecting hole may be formed in a rear central portion of the second plate.

The hydraulic space may be formed over an entire surface of the second plate so that the entire surface of the inner brake pad is uniformly pressed when the working fluid is introduced through the tube.

The tube and the connecting hole may be provided as a plurality of tubes and a plurality of connecting holes, and the working fluid may be introduced into the hydraulic space through the plurality of tubes and connecting holes.

The connecting holes may be formed to be spaced apart from each other at equal intervals in a horizontal direction on both sides from the center of the second plate.

The connecting hole may be formed in a rear central portion of the second plate.

The hydraulic space may be formed over the entire surface of the second plate so that the entire surface of the inner brake pad is uniformly pressed when the working fluid is introduced through the tube.

A plurality of the tubes and the connecting holes may be provided, and the working fluid may be introduced into the hydraulic space through the plurality of tubes and connecting holes.

The connecting holes may be formed to be spaced apart from each other at equal intervals in a horizontal direction on both sides from the center of the second plate.

The tube may elastically extend so that the second plate is movable toward the brake disc when the working fluid is introduced.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a conventional disc brake operated by a piston;

FIG. 2 is a view illustrating a disc brake according to an embodiment;

FIG. 3 is a view illustrating an inner back plate and a tube of the disc brake according to an embodiment;

FIG. 4 is a view illustrating the inner back plate and tubes of the disc brake according to another embodiment;

FIG. 5 is an enlarged view of portion A of the FIG. 2; and

FIG. 6 is a view illustrating the movement of the inner back plate toward the brake disc according to the inflow of a working fluid in FIG. 5.

### DETAILED DESCRIPTION

Hereinafter, embodiments of the present invention will be described in detail with reference to the accompanying drawings. The following examples are presented to sufficiently convey the spirit of the present invention to those skilled in the art. The present invention may be embodied in other forms without being limited to only the embodiments presented herein. In the drawings, in order to clarify the present invention, illustration of parts irrelevant to the description may be omitted, and the size of components may be slightly exaggerated to aid understanding.

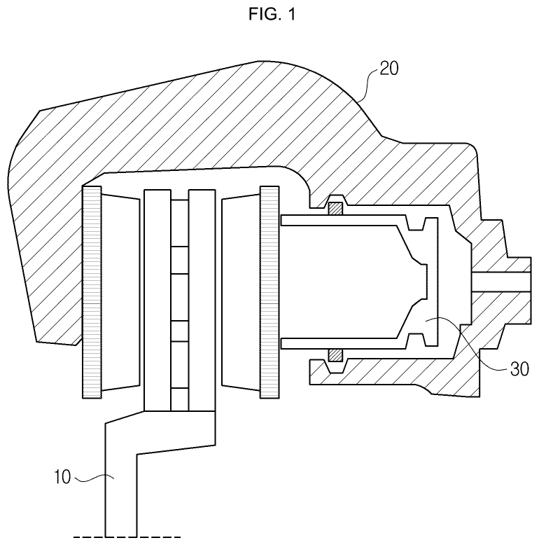

FIG. 1 is a view illustrating a conventional disc brake operated by a piston.

Referring to FIG. 1, in the conventional disc brake, a brake disc 10 that rotates together with wheels of a vehicle (not shown), a pair of brake pads disposed on both sides of the brake disc, and a piston 30 installed to move forward and backward in a housing 20 may be installed. When a driver steps on a brake pedal and hydraulic pressure is ejected from a master cylinder and flows into a space between the cylinder and the piston 30 inside the housing 20, hydraulic pressure formed in the piston 30 and a pair of brake pads are pressed toward the brake disc 10 to generate a braking force.

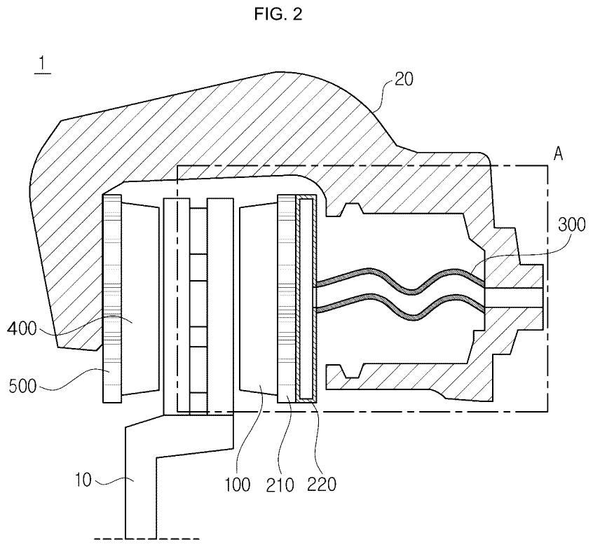

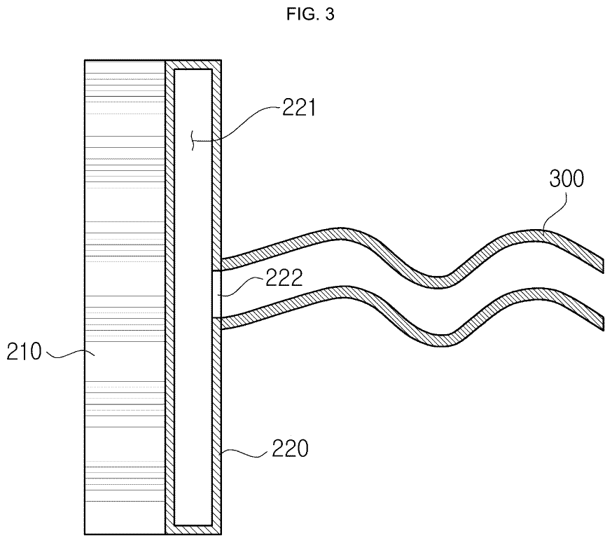

FIG. 2 is a view illustrating a disc brake 1 according to an embodiment. The disc brake 1 according to the embodiment may not include a piston 30 to form hydraulic pressure in a conventional disc brake. FIG. 3 is a view illustrating an inner back plate and a tube of the disc brake according to an embodiment.

Referring to FIGS. 2 and 3, the disc brake 1 according to the embodiment may include an inner brake pad 100 and an outer brake pad 400 provided to rotate together with the wheels of a vehicle and disposed on both sides of the brake disc 10, an inner back plate 200 and an outer back plate 500 supporting outer sides of the inner brake pad 100 and the outer brake pad 400, respectively, with the brake disc 10 interposed therebetween, and a tube 300 for transferring a working fluid to a hydraulic space 221 so that the inner back plate 200 moves toward the brake disc 10 by hydraulic pressure.

The inner brake pad 100 may be fixedly installed on a carrier (not shown), the outer brake pad 400 may be fixedly installed on a bridge (not shown). A separate pressing member such as a piston may not be installed on one side of the inner brake pad 100, and may be fixed in any of various shapes and structures to the housing 20 or a part fixed to the vehicle body.

The outer brake pad 400 may be installed on the other inner surface of the bridge. Accordingly, when the inner brake pad 100 comes into close contact with the brake disc 10 by the hydraulic pressure formed by the working fluid flowing into a hydraulic space 221 through the tube 300 during braking of the vehicle, as a reaction to the close contact, the housing 20 and the bridge connected thereto slide in the opposite direction to the forward movement direction of the inner brake pad 100 with respect to the carrier fixed and installed in a vehicle body, and thus the outer brakepad 400 installed on the bridge may be pressed and come into close contact with the brake disc 10.

The inner back plate 200 and the outer back plate 500 are installed to support the inner brake pad 100 and the outer brake pad 400, respectively. The inner back plate 200 may be arranged such that one surface thereof is connected to the tube 300, and the outer back plate 500 may be arranged such that the other surface thereof is in contact with the bridge. The inner back plate 200 and the outer back plate 500 support a braking torque generated when each of the inner brake pad 100 and the outer brake pad 400 come into contact with the brake disc 10, and may have protrusions formed on both sides thereof to prevent separation from each fixed carrier and bridge.

The inner back plate 200 has the hydraulic space 221 for accommodating a working fluid therein so that the piston 30, which is a conventional pressing member, is replaced. The inner back plate 200 may be provided to move forward from and/or backward to an inner or outer surface of a cylinder provided in the housing 20. The inner back plate 200 may perform braking of the vehicle by moving forward by the hydraulic pressure of a pressurized medium such as brake oil, and may release braking of the vehicle by moving backward.

The inner back plate 200 may include a first plate 210 supporting a rear surface of the inner brake pad 100 and a second plate 220 fixed to a rear surface of the first plate 210. The first plate 210 may support a braking force generated when the inner brake pad 100 is pressed toward the brake disc 10, and may be formed of the same material as the outer back plate 500 supporting a front surface of the outer brake pad 400. The second plate 220 includes the hydraulic space 221 into which a working fluid is introduced so that hydraulic pressure may be formed in the case when the conventional piston is replaced. In the case of a disc brake in which hydraulic pressure is applied to both sides of the brake disc 10, the outer back plate 500 is also composed of a first plate and a second plate, and a hydraulic space into which the working fluid flows may be formed in the second plate.

The second plate 220 may be formed of a material that is more flexible than the first plate 210. That is, the material of the second plate 220 may be provided to be flexible compared to the material of the first plate 210. The first plate 210 is provided with a stiff material such as stainless steel or aluminum to support the inner brake pad 100 without shaking when the brake disc 10 is braked. The second plate 220 is formed of a material having higher flexibility than the first plate 210 and may buffer vibrations generated while the working fluid is introduced into the hydraulic space 221. In the case of the disc brake in which hydraulic pressure is applied to both sides of a brake disc 10, the second plate included in the outer back plate 500 may also be made of a more flexible material than the first plate.

The second plate 220 included in the inner back plate 200 may include the hydraulic space 221 in which the working fluid is introduced to form hydraulic pressure and a connecting hole 222 connected to the hydraulic space 221 and in which an end of the tube 300 is fixed to allow the working fluid to pass therethrough.

The hydraulic space 221 is formed over the entire surface of the second plate 220 so that the entire surface of the inner brake pad 100 may be uniformly pressed when the working fluid flows in from the tube 300. For example, when the second plate 220 is formed in a rectangular shape, the hydraulic space 221 is also formed in the same rectangular shape, but the size thereof may be smaller than that of the second plate 220. In addition, the hydraulic space 221 may be divided into a plurality of spaces and may be designed so that the front surface of the inner brake pad 100 is pressed in a balanced manner by connecting the tube 300 to each of the plurality of divided hydraulic spaces so that the working fluid is simultaneously introduced.

The connecting hole 222 may allow the working fluid introduced from the tube 300 to flow into the hydraulic space 221.

The tube 300 may transfer the working fluid to the hydraulic space 221 so that the second plate 220 included in the inner back plate 200 moves toward the brake disc 10 by hydraulic pressure. As illustrated in FIG. 2, the tube 300 may be disposed in a cylinder inside the housing 20 in which the piston 30 of a conventional disc brake is located.

The tube 300 may be made of a material that elastically extends and/or contracts so that the second plate 220 included in the inner back plate 200 can move toward the brake disc 10 when the working fluid is introduced. The tube 300 may maintain a partially contracted state before the introduction of the working fluid, and then extend and lengthen when the working fluid is introduced. Then, when the inflow of the working fluid is stopped, the tube 300 may be restored to a contracted state.

Referring to FIG. 3, the second plate 220 is formed on the rear surface of the first plate 210, and may include an internal hydraulic space 221 and a connecting hole 222 passing therethrough and connected to the hydraulic space 221. The connecting hole 222 may be connected to the tube 300 through which the working fluid moves. The connecting hole 222 may be formed at the rear center of the second plate 220, and accordingly, when the working fluid flows in from the tube 300, the entire surface of the inner brake pad 100 may be uniformly pressed.

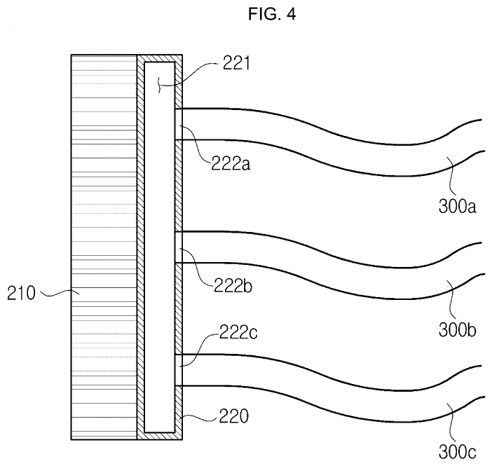

FIG. 4 is a view illustrating the inner back plate 200 and tubes 300 of the disc brake 1 according to another embodiment.

Referring to FIG. 4, a plurality of tubes 300 and connecting holes 222 connected to the tubes 300 may be provided, and a working fluid may flow into one hydraulic space 221 through the plurality of tubes 300 and the plurality of connecting holes 222. When the plurality of connecting holes 222 are provided, the connecting holes 222 are formed to be spaced apart from each other at equal intervals in the horizontal direction on both sides from the center of the second plate 220 included in the inner back plate 200 so that the entire surface of the inner brake pad 100 is pressed evenly when a working fluid is introduced. For example, as shown in FIG. 4, the three tubes 300a, 300b, and 300c are connected to the three connecting holes 222a, 222b, and 222c, respectively, and the three connecting holes 222a, 222b, and 222c may communicate with one hydraulic space 221. One tube 300b and one connecting hole 222b of the tubes 300a, 300b, and 300c and the connecting holes 222a, 222b, and 222c is disposed in the center, and the other tubes 300a and 300c and connecting holes 222a, and 222c may be disposed at positions spaced the same distance from the central portion in both directions. In this case, there may be two or more hydraulic spaces 221, unlike the embodiment of FIG. 4. The number or/and positions of the hydraulic space 221, the tube 300, and the connecting hole 222 may be adjusted according to the design intentions of a technician.

Hereinafter, the principle of braking the brake disc 10 by the disc brake 1 according to a user's braking command will be described

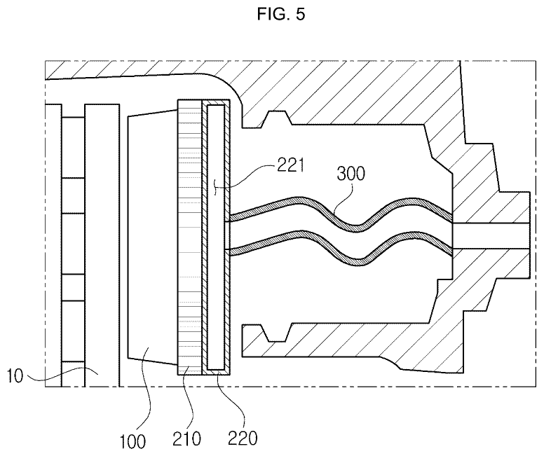

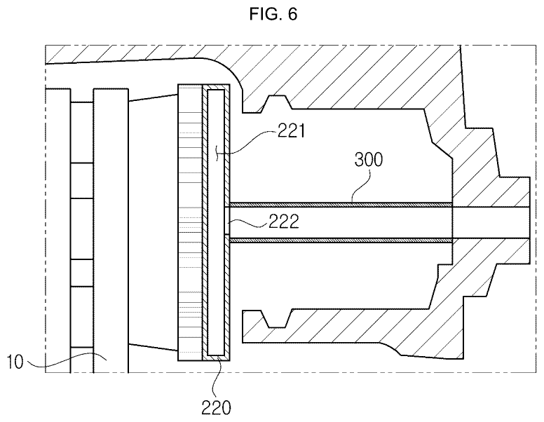

FIG. 5 is an enlarged view of portion A of the FIG. 2, and FIG. 6 is a view illustrating the movement of the inner back plate toward the brake disc according to the inflow of a working fluid in FIG. 5.

Referring to FIG. 5, in a state before the user's braking command is provided, an inner brake pad 100 is separated from a brake disc 10, and hydraulic pressure 221 due to the working fluid may not be formed in the hydraulic space.

Referring to FIG. 6, the working fluid moved through the master cylinder or the like according to the user's braking command flows into the hydraulic space 221 through the tube 300, hydraulic pressure is formed in the hydraulic space 221 so that the first plate 210 is pushed and moved forward, and the length of the tube 300, of which a front end is fixed to the first plate 210, may be extended. The inner brake pad 100 may come into contact with the brake disc 10 according to the movement of the first plate 210 to generate a frictional force. While the inner brake pad 100 moves toward the brake disc 10, the housing 20 and the bridge connected thereto slide and move. At this time, the outer brake pad 400 installed on the bridge may move toward the brake disc 10 to generate a frictional force.

As described above, in the disc brake 1, the inner back plate 200 includes a first plate 210 and a second plate 220, and a hydraulic space 221 and a connecting hole 222 are formed inside the second plate 220, and thus braking power for the brake disc 10 can be generated without a conventional piston 30, and a vehicle weight can be greatly reduced. In addition, the tube 300 of the disc brake 1 is a medium for transferring the working fluid to the hydraulic space 221 inside the second plate 220, and has an effect of increasing productivity due to its light weight and low manufacturing costs.

A disc brake according to an embodiment can replace the conventional piston with a hydraulic space formed inside the back plate so as to significantly reduce vehicle weight.

A disc brake according to an embodiment can be improved from the existing brake pad structure without installing additional parts so as to reduce manufacturing costs and improve productivity.

A disc brake according to an embodiment has a simple structure in which a working fluid flows to the hydraulic space inside the back plate through a tube, and thus the efficiency of assembly and disassembly of the brake can be improved.

As above, the disclosed embodiments have been described with reference to the accompanying drawings. Those skilled in the art to which the present invention pertains will understand that the present invention can be implemented in a form different from the disclosed embodiments without changing the technical spirit or essential features of the present invention. The disclosed embodiments are illustrative and should not be construed as limiting.

What is claimed is:

1. A disc brake comprising:
an inner brake pad and an outer brake pad disposed on both sides of a brake disc;
an inner back plate and an outer back plate configured to support outer sides of the inner brake pad and the outer brake pad, respectively, with the brake disc interposed therebetween;
a hydraulic space formed inside the inner back plate to accommodate a working fluid; and
a tube through which the working fluid is transferred to the hydraulic space so that the inner back plate moves toward the brake disc by hydraulic pressure.

2. The disc brake of claim 1, wherein the inner back plate comprises a connecting hole connected to the hydraulic space, in which the end of the tube is fixed, and through which the working fluid passes.

3. The disc brake of claim 2, wherein the connecting hole is formed in a rear central portion of the inner back plate.

4. The disc brake of claim 2, wherein the hydraulic space is formed over an entire surface of the inner back plate so that the entire surface of the inner brake pad is uniformly pressed when the working fluid is introduced through the tube.

5. The disc brake of claim 2, the tube and the connecting hole are provided as a plurality of tubes and a plurality of connecting holes, and the working fluid may be introduced into the hydraulic space through the plurality of tubes and connecting holes.

6. The disc brake of claim 5, the connecting holes are formed to be spaced apart from each other at equal intervals in a horizontal direction on both sides from the center of the inner back plate.

7. The disc brake of claim 1, the tube elastically extends so that the inner back plate is movable toward the brake disc when the working fluid is introduced.

8. A disc brake comprising:
an inner brake pad and an outer brake pad disposed on both sides of the brake disc;
an inner back plate and an outer back plate supporting outer sides of the inner brake pad and the outer brake pad, respectively, with the brake disc interposed therebetween;
a hydraulic space formed inside the inner back plate to accommodate a working fluid; and
a tube through which the working fluid is transferred to the hydraulic space,
wherein the inner back plate includes:
a first plate supporting a rear surface of the inner brake pad; and
a second plate fixed to a rear surface of the first plate and connected to the tube to form hydraulic pressure by the working fluid.

9. The disc brake of claim 8, wherein the second plate is formed of a material that is more flexible than the first plate.

10. The disc brake of claim 8, wherein the second plate comprises a connecting hole connected to the hydraulic space, in which the end of the tube is fixed, and through which the working fluid passes.

11. The disc brake of claim 10, wherein the connecting hole is formed in a rear central portion of the second plate.

12. The disc brake of claim 10, wherein the hydraulic space is formed over an entire surface of the second plate so that the entire surface of the inner brake pad is uniformly pressed when the working fluid is introduced through the tube.

13. The disc brake of claim 10, wherein the tube and the connecting hole are provided as a plurality of tubes and a plurality of connecting holes, and
the working fluid flows into the hydraulic space through the plurality of tubes and connecting holes.

14. The disc brake of claim 13, wherein the connecting holes are formed to be spaced apart from each other at equal intervals in a horizontal direction on both sides from the center of the second plate.

15. The disc brake of claim 8, wherein the tube elastically extends so that the second plate is movable toward the brake disc when the working fluid is introduced.
